(19) United States
(12) Patent Application Publication
(10) Pub. No.: US 2008/0228695 A1
(43) Pub. Date: Sep. 18, 2008

(54) TECHNIQUES FOR ANALYZING AND PRESENTING INFORMATION IN AN EVENT-BASED DATA AGGREGATION SYSTEM

(75) Inventors: DAVID L. SIFRY, San Francisco, CA (US); Brian Pinkerton, Woodside, CA (US); Richard P. Ault, San Francisco, CA (US); Dorion Carroll, Oakland, CA (US)

Correspondence Address: BEYER WEAVER LLP, P.O. BOX 70250, OAKLAND, CA, 94612-0250, US

(73) Assignee: Technorati, Inc.

(21) Appl. No.: 11/459,217

(22) Filed: Jul. 21, 2006

Related U.S. Application Data
(60) Provisional application No. 60/704,684, filed on Aug. 1, 2005.
(60) Provisional application No. 60/705,223, filed on Aug. 3, 2005.

(51) Int. Cl. G06F 7/06; G06F 17/30

(52) U.S. Cl. 707/2; 707/9; 707/10; 707/E17.017; 707/E17.141

(57) ABSTRACT

Methods and apparatus are described for presenting information relating to event-based data aggregated in an event-based data aggregation system. A dashboard interface is presented which includes report summary data for each of a plurality of reports to which a user has access. Each report corresponds to a subset of the event-based data derived with reference to an associated report rule set. At least one of the report rules sets is editable by the user. The report summary data are updated in response to detection of new event-based data being added to the event-based data aggregation system which match a first one of the report rule sets.

### RELATED APPLICATION DATA

The present application claims priority under 35 U.S.C. 119(e) to U.S. Provisional Patent Application No. 60/704,684 for TECHNIQUES FOR ANALYZING AND PRESENTING INFORMATION IN AN EVENT-BASED DATA AGGREGATION SYSTEM filed on Aug. 1, 2005 (Attorney Docket No. TECHP004P), and to U.S. Provisional Patent Application No. 60/705,223 for TECHNIQUES FOR ANALYZING AND PRESENTING INFORMATION IN AN EVENT-BASED DATA AGGREGATION SYSTEM filed on Aug. 3, 2005 (Attorney Docket No. TECHP004P2), the entire disclosures of both of which are incorporated herein by reference for all purposes. The present application is also related to U.S. patent application Ser. No. 11/157,491 for ECOSYSTEM METHOD OF AGGREGATION AND SEARCH AND RELATED TECHNIQUES filed on Jun. 20, 2005 (Attorney Docket No. TECHP001), the entire disclosure of which is incorporated herein by reference for all purposes.

### BACKGROUND OF THE INVENTION

The present invention relates to techniques for analyzing and presenting information aggregated in event-based data aggregation systems and, more specifically, to providing interfaces in which information of interest to a specific user is presented according to one or more sets of rules defined by the user.

Event-based data aggregation systems have been developed recently by which data on the World Wide Web may be aggregated and indexed in near “real time.” That is, in contrast with the conventional search engine paradigm of continuously and painstakingly crawling the entire web, event-based techniques receive and index posts which may represent, for example, new content published on a web site or in a web log(i.e., blog). Thus, in contrast with conventional search engine techniques by which newly published data may not be indexed for weeks, event-based systems allow dynamic information to be tracked, indexed, and searched minutes rather than weeks

Given the currency and relevance of the information indexed using event-based techniques, it is desirable to provide powerful new ways of making such information available to a community of users.

### SUMMARY OF THE INVENTION

According to the present invention, methods and apparatus are provided for presenting information relating to event-based data aggregated in an event-based data aggregation system. According to a specific embodiment, a dashboard interface is presented which includes report summary data for each of a plurality of reports to which a user has access. Each report corresponds to a subset of the event-based data derived with reference to an associated report rule set. At least one of the report rules sets is editable by the user. The report summary data are updated in response to detection of new event-based data being added to the event-based data aggregation system which match a first one of the report rule sets.

According another specific embodiment, methods and apparatus are provided for applying a plurality of rule sets to event-based data in an event-based data aggregation system. An event notification corresponding to a web log post to be indexed in the event-based data aggregation system is received. The web log post originates from a source. Where the web log post matches a first one of the rule sets, the match is recorded and the source of the web log post is associated with the first rule set. Where the web log post does not match any of the rule sets and the source of the web log post is associated with a second one of the rule sets, a counter for the source of the web log post and the second rule set is incremented.

A further understanding of the nature and advantages of the present invention may be realized by reference to the remaining portions of the specification and the drawings.

### BRIEF DESCRIPTION OF THE DRAWINGS

FIG. 1 is a simplified block diagram of an exemplary event-based data aggregation system which may be employed to implement specific embodiments of the invention.

FIG. 2 is a screen shot of an exemplary interface generated in accordance with specific embodiments of the invention.

FIG. 3 is a screen shot of another exemplary interface generated in accordance with specific embodiments of the invention.

FIG. 4 is a flowchart illustrating a specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention provide a variety of techniques for analyzing and presenting information which is aggregated in event-based systems such as, for example, the system described in U.S. patent application Ser. No. 11/157,491 incorporated herein by reference above. It should be noted, however, that the basic techniques described are not necessarily limited to the system described therein.

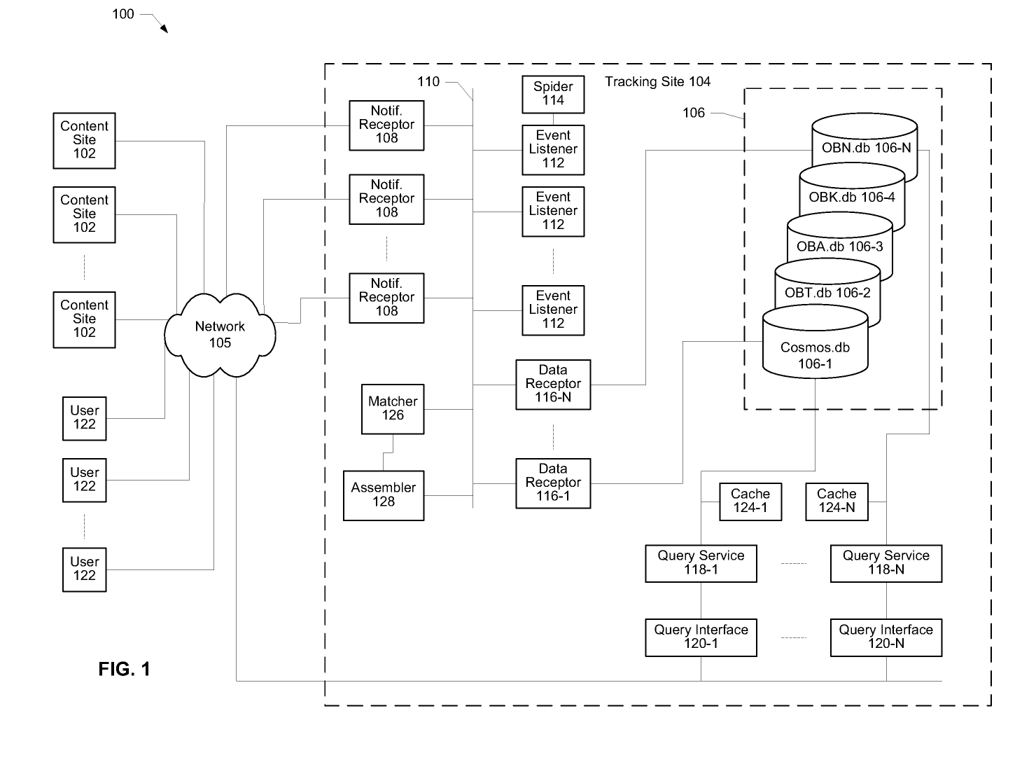

FIG. 1 is a block diagram of one example of an event-based system for which embodiments of the present invention may be useful. The event-based system shown employs a “service-oriented architecture” (SOA) in which the functional blocks referred to are assumed to be different types of services (i.e., software objects with well defined interfaces) interacting with other services in the ecosystem. A service-oriented architecture (SOA) is an application architecture in which all functions, or services, are defined using a description language and have invokable interfaces that are called to perform processes. Each interaction is independent of every other interaction and the interconnect protocols of the communicating devices (i.e., the infrastructure components that determine the communication system) are independent of the interfaces. Because interfaces are platform-independent, a client from any device using any operating system in any language can use the service.

It will be understood, however, that the functions and processes described herein may be implemented in a variety of other ways. It will also be understood that each of the various functional blocks described may correspond to one or more computing platforms in a network. That is, the services and processes described herein may reside on individual machines or be distributed across or among multiple machines in a network or even across networks. It should therefore be understood that the present invention may be implemented using any of a wide variety of hardware, network configurations, operating systems, computing platforms, programming languages, service oriented architectures (SOAs), communication protocols, etc., without departing from the scope of the invention.

In some of the examples below, embodiments of the invention are described with reference to the aggregation and indexing of information primarily relating to content published in web logs, commonly referred to as “blogs.” It should be understood, however, that references to such content and related publishing tools should not be used to limit the scope of the invention. That is, the techniques described herein are much more widely applicable, and may be used to provide access to any type of information which has been (or is being) aggregated and indexed in an event-based system. Examples of other information include, but are not limited to, wiki web page content, social network profiles, or any other type of content published using any general purpose or specialized content management system (CMS) or personal publishing tools. Even more generally, any state change in information on a network which can be characterized and flagged as an event as described herein may trigger the data aggregation and indexing techniques with which embodiments of the present invention may be employed.

Referring now to FIG. 1, an ecosystem 100 in which embodiments of the invention may be implemented will be described. A variety of content sites 102 exist on the Web on which content is generated and published using a variety of content publishing tools and mechanisms, e.g., the blogging tools discussed above. Such publishing mechanisms may reside on the same servers or platforms on which the content resides or may be hosted services.

A tracking site 104 is provided which receives events notifications, e.g., pings, via a wide area network 105, e.g., the Internet, each time content is posted or modified at any of sites 102. So, for example, if the content is a blog which is modified using Type Pad, when the content creator publishes the changes, code associated with the publishing tool makes a connection with tracking site 104 and sends, for example, an XML remote procedure call (XML-RPC) which identifies the name and URL of the blog. Similarly, if a news site post a new article, an event notification (e.g., an XML-RPC) would be generated. Tracking site 104 then sends a “crawler” to that URL to parse the information found there for the purpose of indexing the information and/or updating information relating to the blog in database(s) 106.

Tracking site 104 may also periodically receive aggregated change information. For example, tracking site 104 may acquire change information from other “ping” services. That is, other services, e.g., Blogger, exist which accumulate information regarding the changes on sites which ping them directly. These changes are aggregated and made available on the site, e.g., as a changes.xml file. Such a file will typically have similar information as the pings described above, but may also include the time at which the identified content was modified, how often the content is updated, its URLs, and similar metadata. Tracking site 104 retrieves this information periodically, e.g., every 5 or 10 minutes, and, if it hasn't previously retrieved the file, sends a crawler to the indicated site, and indexes and scores the relevant information found there as described herein.

In addition, tracking site 104 (or closely associated devices or services) may itself accumulate similar change files for periodic incorporation into the database rather than each time a ping is received. In any case, it should be understood that implementations of the ecosystem are contemplated in which change information is acquired using any combination of a variety of techniques.

As will be understood, event notification mechanisms, e.g., pings, may be implemented in a wide variety of ways and may be generally characterized as mechanisms for notifying the system of state changes in dynamic content. Such mechanisms might correspond to code integrated or associated with a publishing tool (e.g., blog tool), a background application on PC or web server, etc.

One or more notification receptors 108, e.g., ping servers, act as event multiplexers taking all of the event notifications coming in from a variety of different places and relating to a variety of different types of content and state changes. Each notification receptor 108 understands two very important things about these events, i.e., the time and origin. That is, notification receptor 108 time stamps every single event when it comes in and associates the time stamp with the URL from which the event originated. Notification receptor 108 then pushes the event onto a bus 110 on which there are a number of event listeners 112.

Event listeners 112 look for different types of events, e.g., press releases, blog postings, job listings, arbitrary webpage updates, reviews, calendars, relationships, location information, etc. Some event listeners may include or be associated with spiders 114 which, in response to recognizing a particular type of event will crawl the associated URL to identify the state change which precipitated the notification. Another type of event listener might be a simple counter which counts the number of events received of all or particular types.

An event listener might include or be associated with a re-broadcast functionality which re-broadcasts each of the events it is designed to recognize to some number of peers, each of which may be designed to do the same. This, in effect, creates a federation of event listeners which may effect, for example, a load balancing scheme for a particular type of event.

Another type of event listener may be configured to listen for and track currently popular keywords (e.g., as determined from the content of blog postings) as an indication of topics about which people are currently talking. Yet another type of event listener looks at any text associated with an event and, using metrics like character type and frequency, identifies the language. In general, event listeners may be configured to look for and track virtually any metric of interest.

Once an event is recognized and the event data have been acquired through some mechanism, e.g., a spider, the output of the event listeners is a set of metadata for each event including, but not limited to, the URL (i.e., the permalink), the time stamp, the type of event, an event ID, content (where appropriate), and any other structured data or metadata associated with the event, e.g., tags, geographical information, people, events, etc. These metadata may be derived from the information available from the URL itself, or may be generated using some form of artificial intelligence such as, for example, the language determination algorithm mentioned above. In addition to spidering, event metadata may be generated by a variety of means including, for example, inferring known metadata locations, e.g., for feeds or profile pages.

A number of databases 106 are maintained in which the event metadata are stored. Each event listener and/or associated spider is operable to check the metadata for an event against the database to determine whether the event metadata have already been stored. This avoids duplicate storage of events for which multiple notifications have been generated. A variety of heuristics may be employed to determine whether a new event has already been received and stored in the database.

Once event metadata have been generated/retrieved and it has been determined that the event has not already been stored in the database, the event is once again put on bus 110. A variety of data receptors 116 (1-N) are deployed on the bus which are configured to filter and detect particular types of events, e.g., blog posts, and to facilitate storage of the metadata for each recognized event in one or more of the databases.

Each data receptor is configured to facilitate storage of events into a particular database. A first set of receptors 116-1 are configured to facilitate storage of events in what will be referred to herein as the Cosmos database (cosmos.db) 106-1 which includes metadata for all events recorded by the system “since the beginning of time.” That is, cosmos.db is the system's data warehouse which represents the “truth” of the data universe associated with ecosystem 100. All other database in the ecosystem may be derived or repopulated from this data warehouse.

Another set of receptors 116-2 facilitates storage of events in a database which is ordered by time, i.e., the OBT.db 106-2. According to a specific embodiment, the information in this database is sequentially stored in fixed amounts on individual machines. That is, once the fixed amount (which roughly corresponds to a period of time, e.g., a day, or a fixed amount of storage) is stored in one machine, the data receptor(s) feeding OBT.db move on to the next machine. This allows efficient retrieval of information by date and time.

Another set of data receptors 116-3 facilitates storage of event data in a database which is ordered by authority, i.e., the OBA.db 106-3. According to a specific embodiment, the information in this database is indexed by individuals and is ordered according to the authority or influence of each which may be determine, for example, by the number of people linking to each individual, e.g., linking to the individual's blog. As the number of links to individuals changes, the ordering within the OBA.db shifts accordingly. Such an approach allows OBA.db to be segmented across machines and database segments to effect the most efficient retrieval of the information. For example, the information corresponding to authoritative individuals, i.e., “influencers,” may be stored in a small database segment with high speed access while the information for individuals to whom very few others link may be stored in a larger, much slower segment.

Authority may also be determined and indexed with respect to a particular category or subject about which an individual publishes. For example, if an individual is identified as writing primarily about the U.S. electoral system, his authority can be determined not only with respect to how many others link to him, but by how many others identifying themselves as political commentators link to him. The authority levels of the linking individuals may also be used to refine the authority determination. According to some embodiments, the category or subject to which a particular individual's authority level relates is not necessarily limited to or determined by the category or subject explicitly identified by the individual. That is, for example, if someone identifies himself as a political blogger, but writes mainly about sports, he will be likely classified in sports. This may be determined with reference to the content of his posts, e.g., keywords and/or links (e.g., a link to ESPN.com).

Yet another set of data receptors 116-4 facilitate storage of event data in a database which is ordered by keyword, i.e., the OBK.db 106-4. These data receptors take the keywords in the event metadata for an incremental keyword index which is periodically (e.g., once a minute) constructed. According to a specific implementation, these data receptors are tuned to enable high speed, near real-time indexing of the keywords.

Once the event metadata are indexed in the database, they are accessible to query services 118 which service queries by users 122. In contrast with the approach taken by the typical search engine, this process typically takes less than a minute. That is, within a minute of changes being posted on the Web, the changes may be available via query services 118. As will be discussed, this makes it possible to track conversations on any subject substantially in real time.

According to some embodiments, caching subsystems 124 (which may be part of or associated with the query services) are provided between the query services and the database(s). The caching subsystems are stored in smaller, faster memory than the databases and allow the system to handle spikes in requests for particular information. Information may be stored in the caching subsystems according to any of a variety of well known techniques, but due to the real-time nature of the ecosystem, it is desirable to limit the time that any information is allowed to reside in the cache to a relatively short period of time, e.g., on the order of minutes or hours. According to a specific implementation, information is inserted into the cache with an expiration time at which time, the information is deleted or marked as “dirty.” If the cache fills up, it operates according to any of a variety of well known techniques, e.g., a “least recently used” (LRU) algorithm, to determine which information is to be deleted.

Query services 118 corresponding to each of the databases in the ecosystem (e.g., cosmos.db, OBT.db, OBA.db, OBK.db, etc.) look at incoming search queries (via query interfaces 120) to determine type, e.g., a keyword vs. URL search, with reference to the syntax or semantics of the query, e.g., does the query text include spaces, dots (e.g., “dot” com), etc. According to some implementations, these query services may be deployed in the architecture to statelessly handle queries substantially in real time.

Keyword searching may be used to identify conversations relating to specific subjects or issues. “Cosmos” searching may enable identification of linking relationships. Using this capability, for example, a blogger could find out who is linking to his blog. This capability can be particularly powerful when one considers the aggregate nature of blogs.

That is, the collective community of bloggers is acting, essentially, as a very large collaborative filter on the world of information on the Web. The links they create are their votes on the relevance and/or importance of particular information. And the semi-structured nature of blogs enables a systematic approach to capturing and indexing relevant information. Providing systematic and timely access to relevant portions of the information which results from this collaborative process allows specific users to identify existing economies relating to the things in which they have an interest.

By being able to track links to particular content, embodiments of the invention enable access to two important kinds of statistical information. First, it is possible to identify the subjects about which a large number of people are having conversations. And the timeliness with which this information is acquired and indexed ensures that these conversations are reflective of the current state of the “market” or “economy” relating to those subjects. Second, it is possible to identify the content authors who may be considered authorities or influencers for particular subjects, i.e., by tracking the number of people linking to the content generated by those authors.

In addition, the ecosystem of FIG. 1 is operable to track what subject matter specific individuals are either linking to or writing about over time. That is, a profile of the person who creates a set of documents may be generated over time and used as a representation of that person's preferences and interests. By indexing individuals according to these categories, it becomes possible to identify specific individuals as authorities or as influential with respect to specific subject matter. This enables the creation of a rich, detailed breakdown of the relative authority of each author across all topics in an ontology, based on the number of inbound links by other authors who create documents in that category.

And because the ecosystem “understands” when a piece of content, e.g., post, link, phrase, etc., was created, this information may be used as an additional input to any analysis of the data. For example, using time to enhance the understanding of influence of a document (or of an author who created the document) by looking at the patterns of inbound linking to a set of documents, you can quickly determine if someone is early to link to a document or late to link to a document. If a person consistently links early to interesting documents, then that person is most likely an expert in that field, or at least can speak authoritatively in that field.

Identifying and tracking authorities for particular subjects enables some capabilities not possible using conventional search engine methodologies. For example, the relevance of a new document indexed by a search engine is completely indeterminate because, by virtue of its being new, no one has yet linked to it. By contrast, because the ecosystem of FIG. 1 is operable to track the influence of a particular author in a given subject matter area, new posts from that author can be immediately scored based on the author's influence. That is, using the newfound understanding of time and personality in document creation, we are able to immediately score new documents even though they are not yet linked widely because we know (a) what is in the new/updated document and can therefore use classification methods to determine its topic, and (b) the relative authority of the author in the topic area described. So, in contrast with traditional search engines, the ecosystem of FIG. 1 can provide virtually immediate access to the most relevant content.

As should be apparent, the event-driven ecosystem of FIG. 1 looks at the World Wide Web in a different way than conventional search technologies. That is, the approach to data aggregation and search described above understands timeliness (e.g., two minutes old instead of two weeks old), time (i.e., when something is created), and people and conversations (i.e., instead of documents). Thus, the ecosystem of FIG. 1 enables a variety of applications which have not been possible before. For example, such an ecosystem enables sophisticated social network analysis of dynamic content on the Web. The ecosystem can track not only what is being said, but who is saying it, and when. Using such an approach, it is possible to analyze how ideas propagate on the Web, and to determine who is influential, authoritative, or popular. It is also possible to determine when people linked to a particular person. This kind of information may be used to enable many kinds of further analysis never before practicable.

According to specific embodiments of the invention, a variety of techniques are provided by which customized access to event-based data may be provided. According to a particular embodiment, a dashboard interface is provided in which information of interest to a specific user is presented according to one or more sets of rules defined by the user. Dashboard may include one or more report summaries corresponding to reports designed to retrieve and organize specific information from the underlying event-based data aggregation system.

According to a specific embodiment, the report summaries may correspond to all of the different reports available to the specific user. For example, the entries at the top of the list refer to reports owned and editable by the user. The entries in the middle of the list refer to reports readable (but not editable) by the user. The entries at the bottom of the list refer to reports readable (but not editable) by the user through group membership.

According to embodiments in which the data indexed in the underlying event-based system relates primarily to blogs, i.e., blog intelligence embodiments, each report summary may include a graph showing conversations of interest over some programmable time period (e.g., 30 days), references to some number (e.g., five) of the last (i.e., most recent) conversations, and references to the activities of specific influencers over some programmable time period (e.g., 30 days).

In the context of one such blog intelligence embodiment, report data may be viewed in four core areas of information gathering referred to herein as Conversations, Influencers, Attention Index, and Blog Information. As will be understood, report data (either in the report summaries of the dashboard or in the reports themselves) may be presented in a variety of ways including, without limitation, hypertext links, images, textual excerpts, textual lists, and graphical representations. Report views may also be generated for a variety of time intervals, e.g., a month, a week, a day, etc.

Report views may include a wide variety of information relating to the topic of interest. For example, a typical report might include the name of the report, and a summary of the outbound links as derived from the data in the underlying event-based system which match a particular rule set associated with the user. A count associated with a particular rule set may also be provided which represents the number of times that the rule has matched incoming events. According to a specific embodiment, a representation of a barometer or “velocity” metric is provided which represents the rising or falling relevance of a topic or individual. Link titles corresponding to any link identified in the report view may also be provided. The media type (e.g., blog, news, general Web, etc.) associated with identified links may be specified. The relevant time segmentation for specific information represented in the report may be identified, e.g., indexed within the last 12 hours. Documentation and explanation of what conditions need to be met for a given rule or rule set, or why any item is in a report may also be included, e.g. by a “Match details” or “Matched these Rules” section. Report views may include a wide variety of analytics relating to matching events and posts such as, for example, term frequency analysis (i.e., how often specific terms occur over time) and sentiment analysis. Sentiment analysis is a set of methods for determining what positive, neutral, or negative tone a post may be conveying about a specific term and may be done with a variety of methods such as, for example, positive/neutral/negative term correlation with the target term. Users may also be provided the capability to export any data represented in report views generated according to the invention to any of a wide variety of devices and formats, e.g., download to .csv, .txt, .pdf, .doc, etc.

According to a specific embodiment, each report dataset is defined to have a minimum size (look back) at the time of rule creation, e.g., 180 days, which is extensible to the full depth and breadth of the database(s) of the underlying event-based data aggregation system. Updates to the report dataset happen in near real-time; real-time being defined in an embodiment implemented with the ecosystem of FIG. 1 as the rate of spider to index, i.e., entry into the database(s). Implementations are contemplated in which report datasets may grow virtually without limit. Dataset analysis can be expanded or restricted by user specified time frames, e.g., 1, 7, 30, 90, 120, 180 days, for all views. These selected timeframe persist over sessions and reflect on analyses. In addition, a user may be notified of changes to any of his reports or his dashboard through automated notifications alerts using such mechanisms as, for example, email, SMS messages, IM messages, etc.

According to specific embodiments of the invention, users may create or specify the rule sets from which these report datasets are derived. Such rules may include an arbitrary number of named conditions which may be expressed using expression matching syntax and combined using Boolean logic. For example, conditions may include a set of keywords, phrases, and/or URLs. Conditions may allow for specific syntax such as, for example, two-letter words (e.g., “HP”). According to a specific embodiment, keyword conditions are Boolean/Lucene searches containing AND, OR, NOT, Quoted Text, and Groupings through parentheses.

Rules and their associated conditions are date stamped. Rule changes invalidate existing result sets and triggers a new look back (e.g., 180 days). According to a specific embodiment of the invention, rule creators are given the capability of verifying rule feasibility through the application of preliminary “what if” scenarios to the underlying dataset.

Individual rules may stitch together to create a filter which is applied to the underlying database(s) as well as to incoming posts to look for matches. According to some embodiments, report data may be generated using the same mechanisms employed to capture events (e.g., blog posts) in the underlying database(s) as those events occur in real time.

According to a specific blog intelligence embodiment, the “Conversations” view includes matches for any mention (or link to) any of the user specified rules. According to the embodiment shown, this information is presented as a list of blog post excerpts with associated metadata representing, for example, rudimentary blog and post summary information. These are listed in reverse chronological order by default, but may be sorted according to other metrics such as, for example, according to the strength of influence of the individual publishing the content. Users can click through each entry to read each individual blog post for a deeper look.

According to a more specific embodiment, a dynamic bar chart is provided representing the volume of posts across a user specified timeframe. The bar chart itself may be selectable as a mechanism to provide granular drilldown, i.e., more detailed information regarding any aspect of the data represented.

According to a specific embodiment, the Conversations view may include a Threaded View for a given report which identifies posts which belong to a thread. According to some embodiments, such a threaded view might also show in a hierarchical display which posts responded to which other posts.

The “Influencer” view may include a list of influential blogs or bloggers (i.e., “influencers”) posting information which matches any of the user specified rules within the user specified time frame. As with the Conversations view, metadata identifying the blog or blogger may be provided. The entries may be sorted by strength of influence, i.e., with the most influential blog or blogger appearing at the top. As discussed above, influence may be represented, for example, by the number of inbound links to the blogiblogger. Each influencer identified in the view has an associated list of the last 3 postings matching the rule(s), and may include an excerpt of the latest matching post.

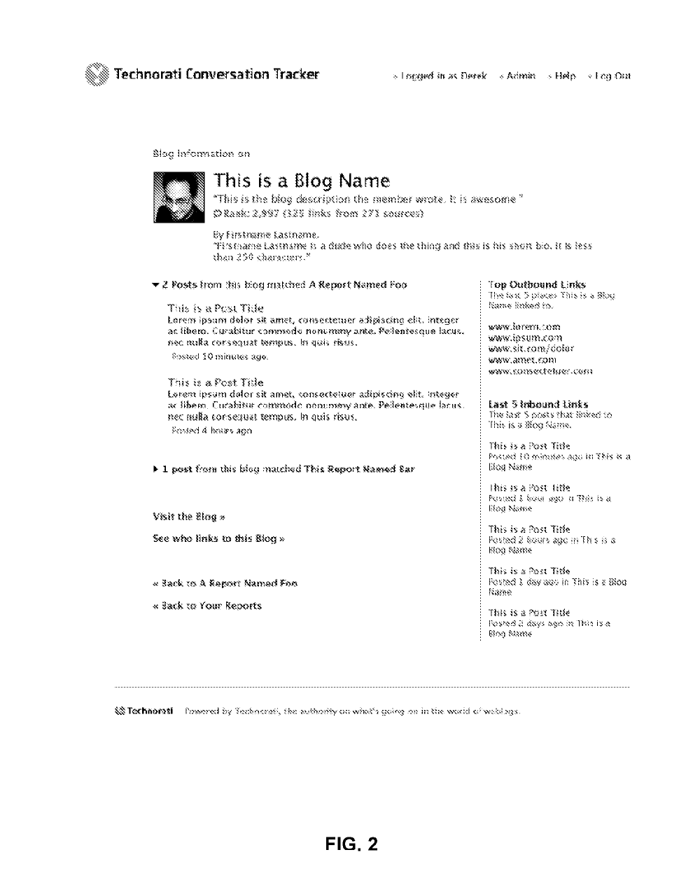

The “Blog Information” view may provide a kind of dossier about a specific blog or blogger having posts which match any of the user's rules. Again, various metadata describing the blog or blogger may be provided including, for example, some indicator of authority or influence, biographical or demographic information, etc. The view may include information about specific and/or recent postings which match one of the user's rules. The view may also include outbound and inbound link information (i.e., what they link to, and who links to them), as well as the recent post history from their blog. Images such as, for example, Webshots or blog screenshots, or thumbnails of such images may also be included. An exemplary Blog Information view is shown in FIG. 2.

The “Attention Index” view may include information identifying the most frequently linked to websites by a community of interest which is defined by the blogs and/or bloggers which match a particular user rule set. The Attention Index view may provide information for the community of interest which specifically relates to the user's rule set. In addition, because the community of interest typically blogs or engages in conversations regarding a wide variety of things, information is also provided about things outside the scope of those specific rules. That is, Attention Index view is intended to describe these other areas of interest by providing a listing of blogs or web sites to which the community of interest is collectively paying attention. So, for example, the Attention Index view may include a listing of web sites to which members of the community of interest commonly link ordered by the most frequently linked to, to the least frequently linked to.

According to a specific embodiment, the Attention Index view provides a list of outbound links over a sliding window of time, e.g., 48 hours, calculated and updated in near real time as events are processed by the underlying event-based system. The entries are ordered by occurrence, paginated, and limited by default or selection. Each entry identifies a topic (e.g., as described by the outbound link), and a list of the most influential bloggers who linked to the target (as established through inbound links), along with the post excerpt where the link occurred.

Attention in this context is any affordance of time that a person or group allocates towards a topic or activity. Merely reading a blog may qualify as a form of attention. A blogger linking to other blogs or articles and writing about them is another form of attention. According to a specific embodiment, a community of interest is defined as all authors or publishers who triggered at least one match with a posting over some programmable time period, e.g., the past 90 days.

The Attention Index view is intended to provide insight into the interests of and thematic areas covered by the community of interest which engages in conversations matching a user's rule set, e.g., bloggers who spoke about topic “ABC” also had conversations about “XYZ.” An attention retrieval service designed in accordance with the invention would receive a user's rule set as its input and, applying the rule set to the underling dataset, generate as output a set of matching entries corresponding to outbound links, the entries identifying the outbound links, and the blogs and the specific posts by the links were published.

According to specific embodiments, the Attention Index view includes the name/title of the target hyperlinked to the URL of the target along with a number indicating the count of matches. This is followed by a table or listing of any of the following items as appropriate for the target: the name of an influencer hyperlinked to their website and/or to a page providing more detailed information about the influencer, along with a number indicating the count of links from the influencer; the rank of an influencer along with the number of inbound blogs to the influencer; and an excerpt from a post by the influencer, either a specially determined post given the rules above, or perhaps just a sample post.

According to various embodiments, the Attention Index view may also include a variety of other information. For example, the title of a page (the target) hyperlinked with the URL of that page may be included. In addition, a list of blogs and/or blog posts (typically most recent) linking to the target may be included. Such a list may be limited by selection (e.g. by the user or an administrator) or default. Each item in the list may include the name/title of the blog and/or blog post and can be hyperlinked either to the URL of the blog and/or blog post, or to a page which shows more detailed information about the blog and/or blog post.

The list of blogs and/or blog posts may be sort ordered by how often or recently they link to the target, or by how influential the blog and/or blog post is. All orders may also be reversed to provide additional relevance and perspective. Any of the sort orders may also be combined, e.g., reverse ordered first by most commonly linked to target, and then by most influential blogger linking to the target.

The name/title of any blog or blog post may be hyperlinked either to the URL of the blog post and/or to a set of search results from the underlying database(s) which identify all links to the blog post itself. Each URL (e.g., including blogs and/or blog posts) may include next to it the number of inbound Links and/or blogs that are linking to the URL. Blogs and blog posts may display content and post excerpts. Content and post excerpts can be limited to only some blogs and blog posts, e.g. to those attributable to the top four influencers.

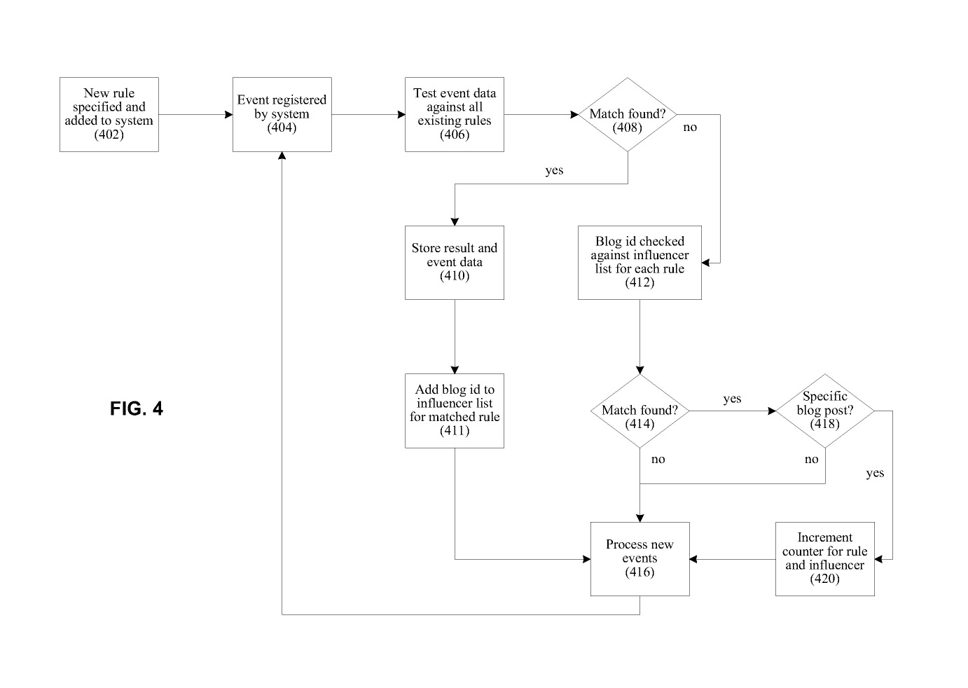

According to a specific embodiment of the invention relating to blog intelligence, rules or rule sets are handled according to the process illustrated by the flowchart of FIG. 4. A new rule is specified (e.g., by a user or administrator) and added to the system (402). At that point the rule has not yet been applied and therefore does not have any matching results. When an event, e.g., a blog post, is registered by the system (404), the associated data (e.g., blog post content and/or metadata) are tested against all existing rules (406). If a match is found (408), the result associating the blog post with the rule and the blog post data are persisted into a storage mechanism (410). That is, for each rule in the system, the system is continuously identifying new posts that match the rule, and storing an entry for every match for every rule.

According to one embodiment, the blog identifier is added to a list of influencers associated with the matched rule (411). That is, for each rule in the system, the system is also continuously identifying influencers which match each rule by determining the source of the post matches.

If the blog post does not match any existing rules (408), the blog identifier associated with the post is checked against the list of influencers for each rule (412). That is, even where the post itself does not match a rule, the system determines whether it was posted by an individual who matches the rule as an influencer. If there is no match (414), the system continues processing new events entering the system (416).

If the blog post was posted by an influencer (414), and if there is a post identifier for the blog post (418), a counter associated with the rule and the influencer (i.e., the blog identifier) is incremented (420). If there is such no post identifier (418), the system continues processing new events entering the system (416).

Tracking the posts from an influencer for a given rule (see 420 above) allows the system to support the “also had conversations about” feature discussed above, e.g., by analyzing tags. In addition, this information may be used for determining what percentage of an influencer's posts are relevant to the topic/match at hand.

According to various embodiments of the invention, a variety of administrative functions and interfaces may be provided in a system implemented in accordance with the invention. According to a specific embodiment, different types of system users and accounts are contemplated having different levels of access and privileges in the system. An “administrator” has access to global settings and can administrate all account settings.

A “super user” has the ability to provision regular “users,” and can create “groups” which are collections of users able to access all reports created by or accessible to other group members. Super users can approve report creation, and can assign pools of available report slots to users. A regular “user” can read, write, and create his own reports.

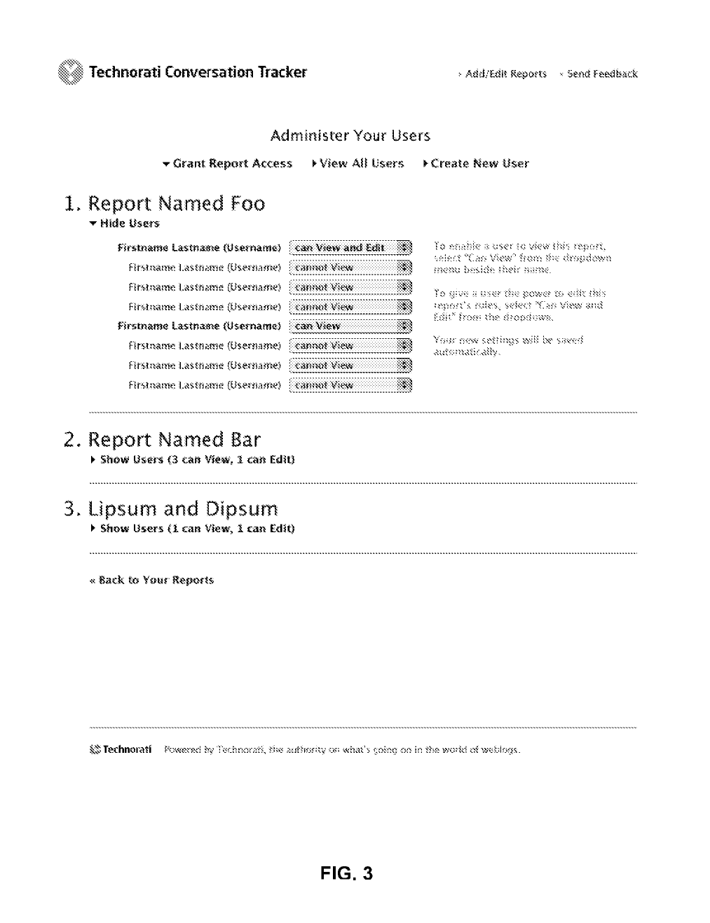

An exemplary report administration interface is shown in FIG. 3.

As mentioned above, embodiments of the present invention enable the tracking of information of interest to a particular user substantially in real time. That is, in addition to looking backwards, i.e., at information already indexed in the database(s) of the underlying event-based system, for matches, tracking processes (also referred to herein as “matchers”) look at or “listen for” matches on incoming information as it is being indexed. The following describes the behavior of a particular implementation of such a process.

According to a specific embodiment and referring once again to FIG. 1, a matcher 126 (of which there may be many) listens on message bus 110 for blogs, posts, links, and/or tags. According to a particular implementation, an assembler 128 waits up to 3 minutes for enough messages before it decides it has seen all change events pertaining to a single blog and flushes its 3 minute queue. If an item that gets flushed is a blog update, everything assembled to that point in time for that blog gets pushed. The spider then sends an ‘admin’ message to indicate that it is done with spidering the blog.

Matcher 126 listens for these messages, looking for matches according to any of the following. With regard to fields, the matcher looks at basically anything that comes over the bus. The matcher may also look at authority/influence for a blog (e.g., as determined from blogs table). Matchers may work with a variety of operators, e.g., relational; regular expression, i.e., regex, operators on strings (e.g., may use regular Java included regex); fulltext operates on string (like post.content); set “is in”; etc. Rules are read periodically (e.g., once a minute) to see if there are new rules. According to a specific embodiment, rules are parsed once for fulltext so they aren't parsed on every execute. An evalulation context is created from the output of the assembler. It creates a mini-index of the post content and matches the pre-compiled parsed queries.

When the matcher determines that a match exists (e.g., with rule id, link, authority, and created time), it generates a new rule idiblog id combination for use in the Attention Index view. On startup, the rule idiblog id combos are bootstrapped from the results in steady state, and the Attention Index view just gets what the matcher identifies for it. For each rule id, there is a list of such attention entries.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for presenting information relating to event-based data aggregated in an event-based data aggregation system, comprising:
presenting a dashboard interface to a user, the dashboard interface including report summary data for each of a plurality of reports to which the user has access, each report corresponding to a subset of the event-based data derived with reference to an associated report rule set, at least one of the report rules sets being editable by the user; and
updating the report summary data in response to detection of new event-based data being added to the event-based data aggregation system, the new event-based data matching a first one of the report rule sets.

2. The method of claim 1 wherein each of the report rules sets employs any of expression matching syntax, Boolean operators, and time interval specification.

3. The method of claim 1 further comprising enabling the user to edit a first one of the rule sets.

4. The method of claim 3 further comprising invalidating a first result set derived by application of the first rule set to the event-based data for a first time interval, and generating a new result set by applying the edited first rule set to the event-based data for a second time interval.

5. The method of claim 3 further comprising enabling the user to test the first rule set against the event-based data.

6. The method of claim 1 further comprising transmitting a notification to the user in response to updating the report summary data.

7. The method of claim 1 further comprising presenting a report view for one of the reports in response to selection of the corresponding report summary data in the dashboard interface, the report view being derived with reference to a portion of the event-based data indexed during a programmable time interval.

8. The method of claim 7 wherein the report view includes any of match information identifying a portion of the associated report rule set from which the report view was derived, term frequency information, and sentiment analysis information.

9. The method of claim 7 further comprising enabling the user to export at least a portion of the report view into a different electronic format.

10. The method of claim 7 wherein the report view comprises a conversations report view which identifies web log posts matching the report rule set associated with the conversations report view.

11. The method of claim 10 further comprising at least one of (1) presenting references to the web log posts in chronological order in the conversations report view, and (2) presenting references to the web log posts in order of influence as determined with reference to sources of the web log posts in the conversations report view.

12. The method of claim 10 wherein at least some of the web log posts identified in the conversations report view correspond to a conversation thread.

13. The method of claim 7 wherein the report view comprises an influencers report view which identifies sources of web log posts matching the report rule set associated with the influencers report view.

14. The method of claim 13 further comprising identifying additional subject matter in the influencers view which corresponds to additional web log posts associated with the sources, but does not correspond to the report rule set associated with the influencers report view.

15. The method of claim 7 wherein the report view comprises a web log information report view which provides information about a source of at least one web log post matching the report rule set associated with the web log information report view.

16. The method of claim 15 wherein the information about the source of the at least one web log post includes at least one of demographic information, a level of influence, an image, and an excerpt from a corresponding web log.

17. The method of claim 7 wherein the report view comprises an attention index report view which identifies foci of interest for a plurality of entities, each of the plurality of entities comprising a source of at least one web log post matching the report rule set associated with the attention index report view.

18. The method of claim 17 wherein the foci of interest correspond to web sites to which selected ones of the plurality of entities have established outbound links.

19. The method of claim 18 further comprising at least one of (1) presenting references to the outbound links ordered by number of links, and (2) presenting references to the outbound links in order of influence as determined with reference to selected entities.

20. The method of claim 1 further comprising enabling the user to define a group of users, and providing access by each of the group of users to a particular one of the reports.

21. A computer program product comprising at least one computer-readable medium having computer program instructions stored therein which are operable to implement the method of claim 1.

22. A computer-implemented method for applying a plurality of rule sets to event-based data in an event-based data aggregation system, comprising:
receiving an event notification corresponding to a web log post to be indexed in the event-based data aggregation system, the web log post originating from a source;
where the web log post matches a first one of the rule sets, recording the match and associating the source of the web log post with the first rule set; and
where the web log post does not match any of the rule sets and the source of the web log post is associated with a second one of the rule sets, incrementing a counter for the source of the web log post and the second rule set.

23. A computer program product comprising at least one computer-readable medium having computer program instructions stored therein which are operable to implement the method of claim 22.
